(19) United States
(12) Patent Application Publication
(10) Pub. No.: US 2002/0103012 A1
(43) Pub. Date: Aug. 1, 2002

(54) Distributed antenna device for intermediate frequency conversion / process

(76) Inventors: Jong-Kyu Kim, Sungnam-si (KR); Ho-Jun Lee, Seoul (KR)

Correspondence Address: John E. Holmes, Roylance, Abrams, Berdo & Goodman, L.L.P., 1300 19th Street, N.W., Suite 600, Washington, DC, 20036, US

(21) Appl. No.: 09/791,659

(22) Filed: Feb. 26, 2001

(30) Foreign Application Priority Data
Jan. 30, 2001 (KR) 2001-4170

(51) Int. Cl. H04Q 7/20

(52) U.S. Cl. 455/562; 455/422

(57) ABSTRACT

A distributed antenna device for intermediate frequency conversion/process which comprises a distributed antenna module including a plurality of antenna modules packaged therein, each for transmitting and receiving signals to/from a subscriber terminal through a low-power antenna, a hub unit for transmitting and receiving signals to/from a base transceiver station through a certain antenna, and a coaxial cable connected between the hub unit and the distributed antenna module for transferring signals therebetween. According to this invention, the distributed antenna device has the effect of minimizing the number of dead zones and maximizing the entire antenna output capacity with lower power than conventional outdoor switching centers.

### BACKGROUND OF THE INVENTION

1. Field of the Invention

The present invention relates in general to antennas for switching centers used in cellular mobile telecommunication systems, and more particularly to a distributed antenna device for intermediate frequency conversion/process which comprises a distributed antenna module including a plurality of antenna modules packaged therein, each for transmitting and receiving signals to/from a subscriber terminal through a low-power antenna, a hub unit for transmitting and receiving signals to/from a base transceiver station (BTS) through a certain antenna, and a signal line for electrically connecting the hub unit to the distributed antenna module. This invention relates particularly to a distributed antenna device for intermediate frequency conversion/process wherein a plurality of antenna modules are packaged into a single module, thereby reducing the installation cost of the device and enabling the efficient maintenance of the device, and a switching center (hub unit) is provided to receive a radio frequency signal transmitted from a BTS, convert the received radio frequency signal into an intermediate frequency signal, transmit the converted intermediate frequency signal to a subscriber terminal through each of the antenna modules and process a radio frequency signal transmitted from the subscriber terminal in the opposite manner, thereby switching signals with the use of no optical cable and little loss and providing a minimized number of dead zones and a maximized amount of traffic capacity with even a low-power antenna.

2. Description of the Prior Art

In cellular mobile telecommunication systems, generally, mobile terminals are assigned unique telephone numbers and production codes (electronic serial numbers), respectively, so that they can communicate with innumerable terminals on the basis of such unique numbers and codes.

Such a cellular mobile telecommunication system comprises a plurality of BTSs, typically referred to as cell sites, mobile terminals for communicating with other terminals via the BTSs, and switching centers intervened between the BTSs and the mobile terminals for performing voice communication and data communication therebetween.

Conventional switching centers may generally be classified into outdoor switching centers based on a radio frequency signal and optical switching centers based on an optical signal.

FIG. 1 is a block diagram showing the construction of a conventional outdoor switching center. As shown in this drawing, the conventional outdoor switching center comprises a donor antenna 1 for receiving a radio frequency signal transmitted from a BTS, a duplexer 2 for separating radio frequency signals transmitted and received through the donor antenna 1 into a transmission frequency band and a reception frequency band, a low-noise amplifier (LNA) 3 for removing noise components from an output signal from the duplexer 2 and amplifying the level of the resulting signal, a frequency converter 4 for down-converting an output signal from the low-noise amplifier 3 into an intermediate frequency signal, an intermediate frequency filter 5 for filtering the intermediate frequency signal converted by the frequency converter 4 to remove therefrom noise components generated during the frequency conversion by the frequency converter 4, an intermediate frequency amplifier (AMP) 6 for amplifying an output signal from the intermediate frequency filter 5, a frequency converter 7 for up-converting an intermediate frequency signal from the intermediate frequency amplifier 6 into a radio frequency signal, a radio frequency filter 8 for filtering the radio frequency signal converted by the frequency converter 7 to remove therefrom noise components generated during the frequency conversion by the frequency converter 7, a power amplifier (PAM) 9 for amplifying an output signal from the radio frequency filter 8, and a duplexer 10 for transmitting an output signal from the power amplifier 9 to a subscriber terminal through a directional antenna 11 or separating a radio frequency signal from the subscriber terminal, received through the directional antenna 11, from the transmitted signal. The conventional outdoor switching center further comprises a low-noise amplifier 12 for low-noise amplifying a weak radio frequency signal from the duplexer 10, a frequency converter 13 for down-converting an output signal from the low-noise amplifier 12 into an intermediate frequency signal, an intermediate frequency filter 14 for filtering the intermediate frequency signal converted by the frequency converter 13 to remove therefrom noise components generated during the frequency conversion by the frequency converter 13, an intermediate frequency amplifier 15 for amplifying an output signal from the intermediate frequency filter 14, a frequency converter 16 for up-converting an intermediate frequency signal from the intermediate frequency amplifier 15 into a radio frequency signal, a radio frequency filter 17 for filtering the radio frequency signal converted by the frequency converter 16 to remove therefrom noise components generated during the frequency conversion by the frequency converter 16, and a high-power amplifier (HPA) 18 for amplifying an output signal from the radio frequency filter 17 and outputting the amplified signal to the duplexer 2.

A description will hereinafter be given of the operation of the conventional outdoor switching center with the above-stated construction, which consists of a forward operation from the BTS to the subscriber terminal and a reverse operation from the subscriber terminal to the BTS.

First, for the forward operation, a weak radio frequency signal transmitted from the BTS is received through the donor antenna 1 and transferred to the low-noise amplifier 3 through the duplexer 2. The low-noise amplifier 3 low-noise amplifies an output signal from the duplexer 2 and outputs the amplified signal to the frequency converter 4, which then converts the output signal from the low-noise amplifier 3 into an intermediate frequency signal, or a signal of 70 MHz or 140˜170 MHz.

Thereafter, the intermediate frequency filter 5 filters the intermediate frequency signal converted by the frequency converter 4 to remove therefrom noise components generated during the frequency conversion by the frequency converter 4, and the intermediate frequency amplifier 6 amplifies the resulting intermediate frequency signal from the intermediate frequency filter 5. The intermediate frequency signal amplified by the intermediate frequency amplifier 6 is converted into the original radio frequency signal by the frequency converter 7.

The radio frequency filter 8 filters the radio frequency signal converted by the frequency converter 7 to remove therefrom noise components generated during the frequency conversion by the frequency converter 7, and the power amplifier 9 amplifies the resulting radio frequency signal from the radio frequency filter 8. Then, the radio frequency signal amplified by the power amplifier 9 is transmitted to the subscriber terminal via the duplexer 10 and directional antenna 11.

On the other hand, the reverse operation is performed in the opposite manner to the forward operation. In other words, a radio frequency signal transmitted from the subscriber terminal is received through the directional antenna 11 and transferred to the low-noise amplifier 12 through the duplexer 10. The low-noise amplifier 12 low-noise amplifies an output signal from the duplexer 10 and outputs the amplified signal to the frequency converter 13, which then down-converts the output signal from the low-noise amplifier 12 into an intermediate frequency signal.

Subsequently, the intermediate frequency filter 14 filters the intermediate frequency signal converted by the frequency converter 13 to remove therefrom noise components generated during the frequency conversion by the frequency converter 13, and the intermediate frequency amplifier 15 amplifies the resulting intermediate frequency signal from the intermediate frequency filter 14.

The frequency converter 16 converts the intermediate frequency signal amplified by the intermediate frequency amplifier 15 into a radio frequency signal, and the radio frequency filter 17 filters the radio frequency signal converted by the frequency converter 16 to remove therefrom noise components generated during the frequency conversion by the frequency converter 16. Then, the resulting radio frequency signal from the radio frequency filter 17 is transmitted to the BTS through the power amplifier 18, duplexer 2 and donor antenna 1.

However, the above-described conventional outdoor switching center has a disadvantage in that a large number of dead zones exist due to fixed radiation directions of antennas. This outdoor switching center is also disadvantageous in that it is inefficient in increasing a traffic capacity and high in cost. Furthermore, for use of the conventional outdoor switching center, it is required to lease a place where the outdoor switching center is to be installed, at a great cost.

In order to overcome the above problems, there has been proposed an optical switching center comprising a donor unit for transmitting and receiving signals to/from a base transceiver station, an optical hub unit for transmitting and receiving signals between the donor unit and a subscriber terminal, and an optical cable for connecting the donor unit to the optical hub unit.

FIG. 2 is a block diagram showing the construction of a conventional optical switching center. As stated above, the conventional optical switching center comprises a donor unit and an optical hub unit. As shown in FIG. 2, the donor unit includes an attenuator (ATT) 21 for attenuating a radio frequency signal transmitted from a BTS 20 by a predetermined level to remove noise components therefrom, an amplifier (AMP) 22 for amplifying an output signal from the attenuator 21 by a predetermined level, an electric/optical converter (OTx) 23 for converting an output signal from the amplifier 22 into an optical signal, and a wavelength multiplexer/demultiplexer (WDM) 24 for multiplexing a wavelength of the optical signal converted by the electric/optical converter 23 or demultiplexing an optical signal received through an optical cable 25. The donor unit further includes an optical/electric converter (ORx) 38 for converting the optical signal demultiplexed by the wavelength multiplexer/demultiplexer 24 into a radio frequency signal, an attenuator 39 for attenuating the radio frequency signal converted by the optical/electric converter 38 by a predetermined level to remove noise components therefrom, and an amplifier 40 for amplifying an output signal from the attenuator 39 by a predetermined level and transmitting the amplified signal to the BTS 20.

The optical hub unit includes a wavelength multiplexer/demultiplexer 26 for demultiplexing an optical signal from the donor unit, received through the optical cable 25, an optical/electric converter 27 for converting the optical signal demultiplexed by the wavelength multiplexer/demultiplexer 26 into a radio frequency signal, an attenuator 28 for attenuating the radio frequency signal converted by the optical/electric converter 27 by a predetermined level to remove noise components therefrom, an amplifier 29 for amplifying an output signal from the attenuator 28 by a predetermined level, a frequency filter 30 for filtering an output signal from the amplifier 29 to remove noise components therefrom, an amplifier 31 for amplifying an output signal from the frequency filter 30 by such a level that the amplified signal can be transmitted to a subscriber terminal, a duplexer 32 for filtering an output signal from the amplifier 31 to remove noise components therefrom, and a directional antenna 33 for transmitting a radio frequency signal from the duplexer 32 to the subscriber terminal. The optical hub unit further includes a low-noise amplifier 34 for low-noise amplifying a radio frequency signal from the subscriber terminal, received through the directional antenna 33 and filtered by the duplexer 32, an attenuator 35 for attenuating an output signal from the low-noise amplifier 34 by a predetermined level to remove noise components therefrom, an amplifier 36 for amplifying an output signal from the attenuator 35 by a predetermined level, and an electric/optical converter 37 for converting an output signal from the amplifier 36 into an optical signal and outputting the converted optical signal to the wavelength multiplexer/demultiplexer 26.

A description will hereinafter be given of the operation of the conventional optical switching center with the above0 stated construction, which consists of a forward operation from the BTS to the subscriber terminal and a reverse operation from the subscriber terminal to the BTS.

First, for the forward operation, in the donor unit, a radio frequency signal transmitted from the BTS 20 is attenuated by the attenuator 21, amplified by the amplifier 22 and then converted into an optical signal by the electric/optical converter 23.

The optical signal converted by the electric/optical converter 23 is multiplexed by the wavelength multiplexer/demultiplexer 24 and then transmitted to the optical hub unit via the optical cable 25.

In the optical hub unit, the optical signal transmitted from the donor unit is demultiplexed by the wavelength multiplexer/demultiplexer 26, again converted into a radio frequency signal by the optical/electric converter 27, attenuated by the attenuator 28 and then amplified by the amplifier 29.

The radio frequency signal amplified by the amplifier 29 is filtered by the frequency filter 30 and then amplified by the amplifier 31 so that it can be transmitted to the subscriber terminal. Thereafter, the radio frequency signal amplified by the amplifier 31 is transmitted to the subscriber terminal via the duplexer 32 and directional antenna 33.

On the other hand, the reverse operation is performed in the opposite manner to the forward operation. In other words, a radio frequency signal transmitted from the subscriber terminal is received through the directional antenna 33, filtered by the duplexer 32, low-noise amplified by the low-noise amplifier 34, attenuated by the attenuator 35 and then amplified by the amplifier 36.

The radio frequency signal amplified by the amplifier 36 is converted into an optical signal by the electric/optical converter 37.

The optical signal converted by the electric/optical converter 37 is multiplexed by the wavelength multiplexer/demultiplexer 26 and then transmitted to the donor unit through the optical cable 25.

Thereafter, in the donor unit, the optical signal transmitted from the optical hub unit is demultiplexed by the wavelength multiplexer/demultiplexer 24, again converted into a radio frequency signal by the optical/electric converter 38 and then transmitted to the BTS 20 through the attenuator 39 and amplifier 40.

However, for use of the above-described optical switching center, it is necessary to lease a high-cost optical cable line. Further, the conventional optical switching center requires optical units such as optical/electric converters and electric/optical converters and is troublesome to install and maintain.

### SUMMARY OF THE INVENTION

Therefore, the present invention has been made in view of the above problems, and it is an object of the present invention to provide a distributed antenna device for intermediate frequency conversion/process which is capable of minimizing the number of dead zones with the use of neither an optical/electric converter nor electric/optical converter and without leasing a high-cost optical cable line.

It is another object of the present invention to provide a distributed antenna device for intermediate frequency conversion/process which is capable of transmitting signals with little loss via even a general signal line or coaxial cable, not an optical cable, and very efficiently increasing a traffic capacity owing to a low installation cost of a switching center.

In accordance with the present invention, the above and other objects can be accomplished by the provision of a distributed antenna device for intermediate frequency conversion/process, comprising a hub unit including first input/output means for transmitting and receiving radio frequency signals to/from a base transceiver station, second input/output means for transmitting and receiving signals over a signal line, first signal processing means for converting an output signal from the first input/output means into an intermediate frequency signal and processing the converted intermediate frequency signal, and second signal processing means for converting an output signal from the second input/output means into an intermediate frequency signal and processing the converted intermediate frequency signal; a distributed antenna module including a plurality of antenna modules, each of the antenna modules including third input/output means for transmitting and receiving signals to/from the hub unit, fourth input/output means for transmitting and receiving radio frequency signals to/from a subscriber terminal, third signal processing means for converting an output signal from the third input/output means into an intermediate frequency signal and processing the converted intermediate frequency signal, and fourth signal processing means for converting an output signal from the fourth input/output means into an intermediate frequency signal and processing the converted intermediate frequency signal; and the signal line connected between the second input/output means in the hub unit and the third input/output means in the distributed antenna module.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional outdoor switching center;

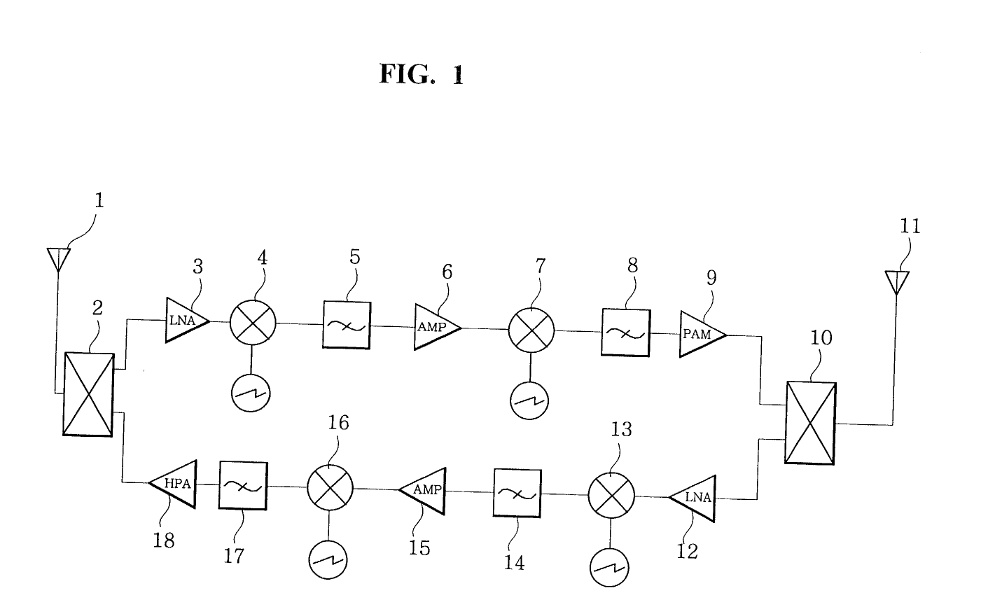

FIG. 2 is a block diagram showing the construction of a conventional optical switching center;

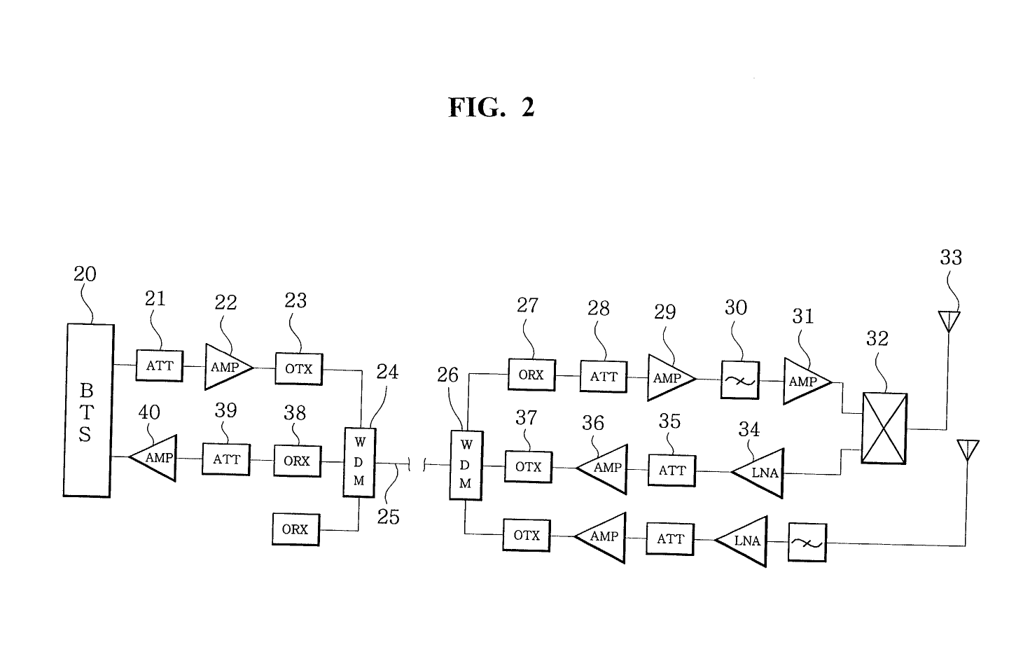

FIG. 3 is a block diagram showing the construction of a distributed antenna device for intermediate frequency conversion/process in accordance with the present invention;

FIG. 4 is a detailed block diagram of a distributed antenna module in FIG. 3; and

FIG. 5 is a view showing an example to which the present invention is applied.

### DETAILED DESCRIPTION OF THE PREFERRED EMBODIMENTS

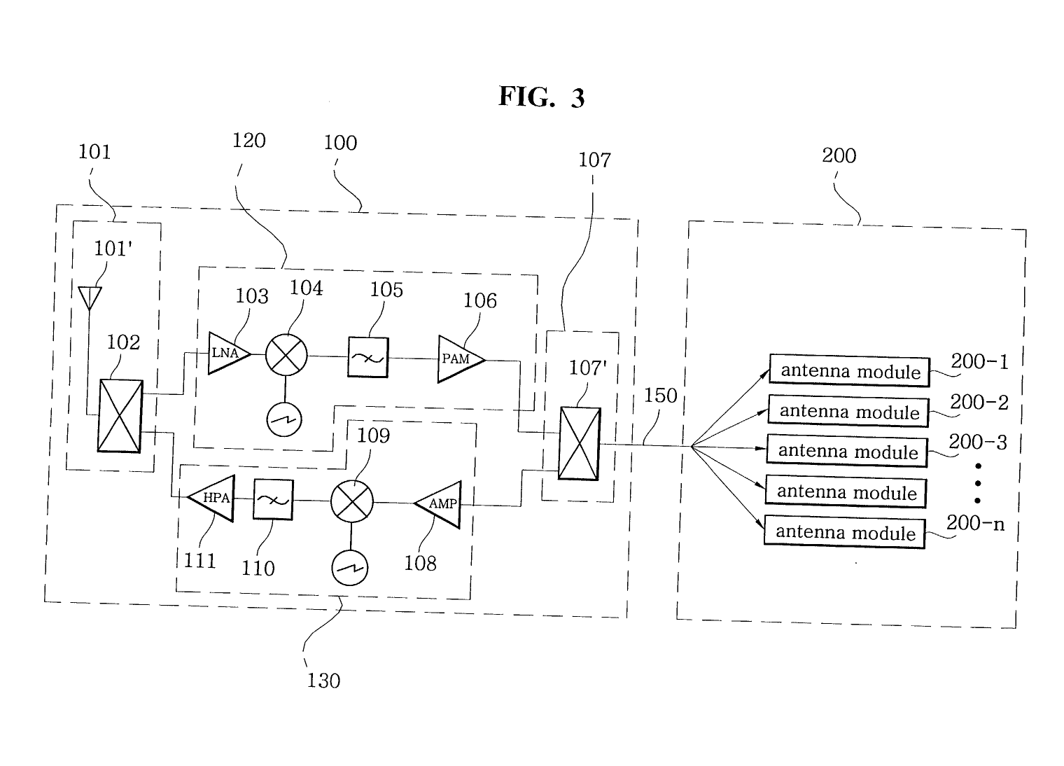

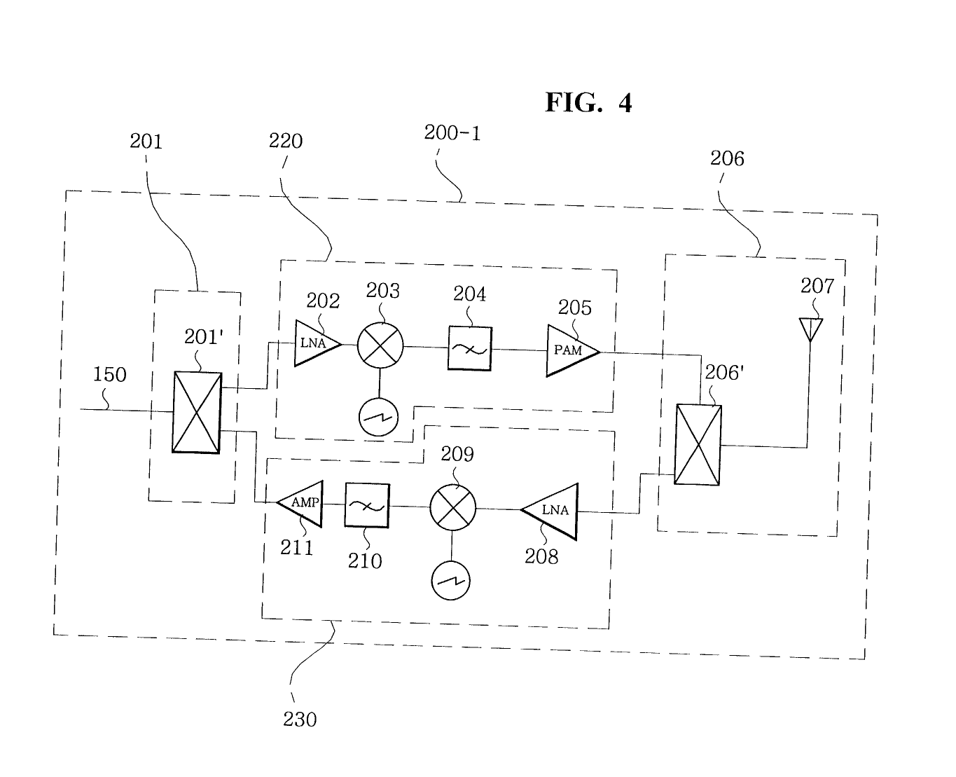

With reference to FIG. 3, there is shown in block form the construction of a distributed antenna device for intermediate frequency conversion/process in accordance with the present invention. As shown in this drawing, the distributed antenna device comprises a hub unit 100, a distributed antenna module 200 and a coaxial cable 150. The hub unit 100 includes a first input/output part 101 having a duplexer 102 connected to a donor antenna 101′ which transmits and receives radio frequency signals to/from a base transceiver station (BTS), a second input/output part 107 having a duplexer 107′ for transmitting and receiving signals over a signal line, a first signal processor 120 for converting an output signal from the first input/output part 101 into an intermediate frequency signal and processing the converted intermediate frequency signal, and a second signal processor 130 for converting an output signal from the second input/output part 107 into an intermediate frequency signal and processing the converted intermediate frequency signal. The distributed antenna module 200 includes a plurality of antenna modules 200-1 to 200-n, each of which includes, as shown in FIG. 4, a third input/output part 201 having a duplexer 201′ for transmitting and receiving signals to/from the hub unit 100, a fourth input/output part 206 having a duplexer 206′ connected to a directional antenna 207 which transmits and receives radio frequency signals to/from a subscriber terminal, a third signal processor 220 for converting an output signal from the third input/output part 201 into an intermediate frequency signal and processing the converted intermediate frequency signal, and a fourth signal processor 230 for converting an output signal from the fourth input/output part 206 into an intermediate frequency signal and processing the converted intermediate frequency signal. The coaxial cable 150 acts to form the above-mentioned signal line between the second input/output part 107 in the hub unit 100 and the third input/output part 201 in the distributed antenna module 200.

In more detail, in the first input/output part 101 of the hub unit 100, the donor antenna 101′ acts to transmit and receive signals to/from the BTS, and the duplexer 102 functions to filter the signals transmitted and received to/from the BTS via the donor antenna 101′.

The first signal processor 120 of the hub unit 100 includes a low-noise amplifier 103 for low-noise amplifying a radio frequency signal from the BTS, received through the donor antenna 101′ and filtered by the duplexer 102, a frequency converter 104 for converting an output signal from the low-noise amplifier 103 into an intermediate frequency signal, a band pass filter (BPF) 105 for filtering the intermediate frequency signal converted by the frequency converter 104 to remove noise components therefrom, and a power amplifier 106 for amplifying the resulting intermediate frequency signal from the band pass filter 105 by such a level that the amplified signal can be transmitted to the distributed antenna module 200 through the coaxial cable 150.

In the second input/output part 107 of the hub unit 100, the duplexer 107′ acts to filter the intermediate frequency signal amplified by the power amplifier 106 of the first signal processor 120 and transmit the resulting intermediate frequency signal to the coaxial cable 150 or filter an intermediate frequency signal from the subscriber terminal, received through the coaxial cable 150.

The second signal processor 130 of the hub unit 100 includes an intermediate frequency amplifier 108 for amplifying the intermediate frequency signal from the subscriber terminal, filtered by the duplexer 107′, a frequency converter 109 for converting the intermediate frequency signal amplified by the intermediate frequency amplifier 108 into the original radio frequency signal, a frequency filter 110 for filtering the radio frequency signal converted by the frequency converter 109 to remove noise components therefrom, and a high-power amplifier 111 for amplifying the resulting radio frequency signal from the frequency filter 110 to a high power level and outputting the amplified radio frequency signal to the duplexer 102.

In the third input/output part 201 of each of the antenna modules 200-1, 200-2, . . . , 200-n in the distributed antenna module 200, as shown in FIG. 4, the duplexer 201′ functions to filter intermediate frequency signals transmitted and received to/from the hub unit 100 through the coaxial cable 150, to remove noise components therefrom.

The third signal processor 220 of each of the antenna modules 200-1, 200-2, . . . , 200-n in the distributed antenna module 200 includes a low-noise amplifier 202 for low-noise amplifying an intermediate frequency signal from the hub unit 100, received through the coaxial cable 150 and filtered by the duplexer 201′, a frequency converter 203 for converting the intermediate frequency signal low-noise amplified by the low-noise amplifier 202 into the original radio frequency signal, a frequency filter 204 for filtering the radio frequency signal converted by the frequency converter 203 to remove noise components therefrom, and a power amplifier 205 for amplifying the resulting radio frequency signal from the frequency filter 204.

In the fourth input/output part 206 of each of the antenna modules 200-1, 200-2, . . . , 200-n in the distributed antenna module 200, the duplexer 206′ functions to filter the radio frequency signal amplified by the power amplifier 205 in the third signal processor 220 and transmit the resulting radio frequency signal to the subscriber terminal through the directional antenna 207 or filter a radio frequency signal from the subscriber terminal, received through the directional antenna 207.

The fourth signal processor 230 of each of the antenna modules 200-1, 200-2, . . . , 200-n in the distributed antenna module 200 includes a low-noise amplifier 208 for low-noise amplifying the radio frequency signal from the subscriber terminal, received through the directional antenna 207 and filtered by the duplexer 206′, a frequency converter 209 for converting the radio frequency signal low-noise amplified by the low-noise amplifier 208 into an intermediate frequency signal, a frequency filter 210 for filtering the intermediate frequency signal converted by the frequency converter 209 to remove noise components therefrom, and an intermediate frequency amplifier 211 for amplifying the resulting intermediate frequency signal from the frequency filter 210 and outputting the amplified intermediate frequency signal to the duplexer 201′.

A detailed description will hereinafter be given of the operation of the distributed antenna device for intermediate frequency conversion/process with the above-stated construction in accordance with the present invention, which consists of a forward operation from the BTS to the subscriber terminal and a reverse operation from the subscriber terminal to the BTS.

First, for the forward operation, a radio frequency signal transmitted from the BTS is received through the donor antenna 101′ of the hub unit 100 and filtered by the duplexer 102 in the first input/output part 101 for the removal of noise components therefrom. Then, in the first signal processor 120, the low-noise amplifier 103 low-noise amplifies an output signal from the duplexer 102 and outputs the amplified signal to the frequency converter 104, which then converts the output signal from the low-noise amplifier 103 into an intermediate frequency signal (70 MHz or 140˜170 MHz). The band pass filter 105 filters the intermediate frequency signal converted by the frequency converter 104 to remove therefrom noise components generated during the frequency conversion by the frequency converter 104.

Thereafter, the resulting intermediate frequency signal from the band pass filter 105 is amplified to a sufficient level by the power amplifier 106 and then transmitted to each of the antenna modules 200-1, 200-2, . . . , 200-n in the distributed antenna module 200 through the duplexer 107′ in the second input/output part 107 and the coaxial cable 150.

In each of the antenna modules 200-1, 200-2, . . . , 200-n in the distributed antenna module 200, the intermediate frequency signal received through the coaxial cable 150 is filtered by the duplexer 201′ in the third input/output part 201 for the removal of noise components therefrom. Then, in the third signal processor 220, the resulting intermediate frequency signal from the duplexer 201′ is low-noise amplified by the low-noise amplifier 202, converted into the original radio frequency signal (869˜894 MHz or 1870˜2170 MHz) by the frequency converter 203 and then filtered by the frequency filter 204 to remove therefrom noise components generated during the frequency conversion by the frequency converter 203.

The resulting radio frequency signal (869˜894 MHz or 1870˜2170 MHz) from the frequency filter 204 is amplified by the power amplifier 205.

Thereafter, the radio frequency signal amplified by the power amplifier 205 is filtered by the duplexer 206′ in the fourth input/output part 206 and then transmitted to the subscriber terminal via the directional antenna 207.

On the other hand, the reverse operation is performed in the opposite manner to the forward operation. In other words, a radio frequency signal transmitted from the subscriber terminal is received through the directional antenna 207 and transferred to the fourth signal processor 230 through the duplexer 206′ in the fourth input/output part 206. Then, in the fourth signal processor 230, the low-noise amplifier 208 low-noise amplifies a weak radio frequency signal from the duplexer 206′ and outputs the amplified signal to the frequency converter 209, which then converts the output signal from the low-noise amplifier 208 into an intermediate frequency signal, or a signal of 70 MHz or 140˜170 MHz.

Subsequently, the frequency filter 210 filters the intermediate frequency signal converted by the frequency converter 209 to remove therefrom noise components generated during the frequency conversion by the frequency converter 209, and the intermediate frequency amplifier 211 amplifies the resulting intermediate frequency signal from the frequency filter 210. Then, the intermediate frequency signal amplified by the intermediate frequency amplifier 211 is filtered by the duplexer 201′ in the third input/output part 201 and transmitted to the hub unit 100 via the coaxial cable 150.

In the hub unit 100, the intermediate frequency signal received through the coaxial cable 150 is filtered by the duplexer 107′ in the second input/output part 107 for the removal of noise components therefrom. Then, in the second signal processor 130, the resulting intermediate frequency signal from the duplexer 107′ is amplified by the intermediate frequency amplifier 108 and transferred to the frequency converter 109.

The frequency converter 109 converts the intermediate frequency signal amplified by the intermediate frequency amplifier 108 into a radio frequency signal (824˜849 MHz or 1750˜1980 MHz), which is then filtered by the frequency filter 110 to remove therefrom noise components generated during the frequency conversion by the frequency converter 109. The resulting radio frequency signal from the frequency filter 110 is amplified to a strong level by the high-power amplifier 111.

Thereafter, the radio frequency signal amplified by the high-power amplifier 111 is filtered by the duplexer 102 in the first input/output part 101 and then transmitted to the BTS via the donor antenna 101′.

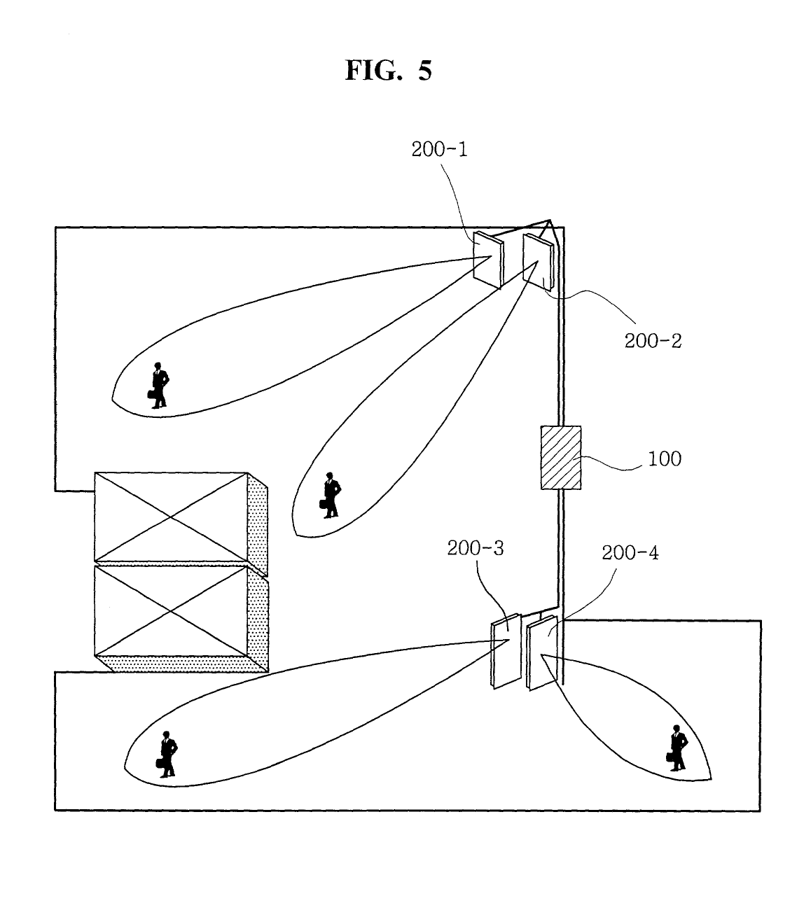

FIG. 5 is a view showing an example to which the present invention is applied. The hub unit 100 receives a radio frequency signal from a BTS and transmits the received radio frequency signal to a corresponding subscriber terminal through the antenna 207 of each of the antenna modules 200-1, 200-2, . . . , 200-n in the distributed antenna module 200. Each antenna 207 is installable with its orientation being adjusted such that its radiation and reception directions can be three-dimensionally adjusted upward, downward, left and right.

Accordingly, without using an optical/electric converter or electric/optical converter and leasing a high-cost optical cable line as in conventional optical switching centers, the distributed antenna module can be configured in such a manner that the radiation and reception directions of each antenna in a cell can be three-dimensionally adjusted upward, downward, left and right. This configuration makes it possible to minimize the number of dead zones and an installation cost of a switching center, thereby very efficiently increasing a traffic capacity.

As apparent from the above description, the present invention provides a distributed antenna device for intermediate frequency conversion/process which is capable of minimizing the number of dead zones and maximizing transmission and reception capacities with lower power than conventional outdoor switching centers. This configuration is economical and environmentally friendly in that it reduces the number of places where switching centers are to be installed and does not require the use of an optical/electric converter or electric/optical converter and a high-cost optical cable line. Further, the distributed antenna device is relatively easy to install and maintain. Furthermore, a signal loss can be reduced by transferring intermediate frequency signals between a hub unit and each antenna module.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A distributed antenna device for intermediate frequency conversion/process, comprising:
a hub unit including first input/output means for transmitting and receiving radio frequency signals to/from a base transceiver station, second input/output means for transmitting and receiving signals over a signal line, first signal processing means for converting an output signal from said first input/output means into an intermediate frequency signal and processing the converted intermediate frequency signal, and second signal processing means for converting an output signal from said second input/output means into an intermediate frequency signal and processing the converted intermediate frequency signal;
a distributed antenna module including a plurality of antenna modules, each of said antenna modules including third input/output means for transmitting and receiving signals to/from said hub unit, fourth input/output means for transmitting and receiving radio frequency signals to/from a subscriber terminal, third signal processing means for converting an output signal from said third input/output means into an intermediate frequency signal and processing the converted intermediate frequency signal, and fourth signal processing means for converting an output signal from said fourth input/output means into an intermediate frequency signal and processing the converted intermediate frequency signal; and
said signal line connected between said second input/output means in said hub unit and said third input/output means in said distributed antenna module.

2. The distributed antenna device as set forth in claim 1, wherein said signal line is a coaxial cable.

3. The distributed antenna device as set forth in claim 1 or claim 2, wherein said first input/output means of said hub unit includes a donor antenna for transmitting and receiving signals to/from said base transceiver station, and a first duplexer for filtering the signals transmitted and received to/from said base transceiver station via said donor antenna;
wherein said first signal processing means of said hub unit includes a low-noise amplifier for low-noise amplifying a radio frequency signal from said base transceiver station, received through said donor antenna and filtered by said first duplexer, a first frequency converter for converting an output signal from said low-noise amplifier into an intermediate frequency signal, a band pass filter for filtering the intermediate frequency signal converted by said first frequency converter to remove noise components therefrom, and a power amplifier for amplifying the resulting intermediate frequency signal from said band pass filter by such a level that the amplified signal can be transmitted to said distributed antenna module through said coaxial cable;
wherein said second input/output means of said hub unit includes a second duplexer for filtering the intermediate frequency signal amplified by said power amplifier of said first signal processing means and transmitting the resulting intermediate frequency signal to said coaxial cable or filtering an intermediate frequency signal from said subscriber terminal, received through said coaxial cable; and
wherein said second signal processing means of said hub unit includes an intermediate frequency amplifier for amplifying the intermediate frequency signal from said subscriber terminal, filtered by said second duplexer, a second frequency converter for converting the intermediate frequency signal amplified by said intermediate frequency amplifier into the original radio frequency signal, a frequency filter for filtering the radio frequency signal converted by said second frequency converter to remove noise components therefrom, and a high-power amplifier for amplifying the resulting radio frequency signal from said frequency filter to a high power level and outputting the amplified radio frequency signal to said first duplexer.

4. The distributed antenna device as set forth in claim 1 or claim 2, wherein said third input/output means of each of said antenna modules in said distributed antenna module includes a first duplexer for filtering intermediate frequency signals transmitted and received to/from said hub unit through said coaxial cable, to remove noise components therefrom;
wherein said third signal processing means of each of said antenna modules in said distributed antenna module includes a first low-noise amplifier for low-noise amplifying an intermediate frequency signal from said hub unit, received through said coaxial cable and filtered by said first duplexer, a first frequency converter for converting the intermediate frequency signal low-noise amplified by said first low-noise amplifier into the original radio frequency signal, a first frequency filter for filtering the radio frequency signal converted by said first frequency converter to remove noise components therefrom, and a power amplifier for amplifying the resulting radio frequency signal from said first frequency filter;
wherein said fourth input/output means of each of said antenna modules in said distributed antenna module includes a second duplexer for filtering the radio frequency signal amplified by said power amplifier in said third signal processing means and transmitting the resulting radio frequency signal to the subscriber terminal through a directional antenna or filtering a radio frequency signal from the subscriber terminal, received through said directional antenna; and
wherein said fourth signal processing means of each of said antenna modules in said distributed antenna module includes a second low-noise amplifier for low-noise amplifying the radio frequency signal from the subscriber terminal, received through said directional antenna and filtered by said second duplexer, a second frequency converter for converting the radio frequency signal low-noise amplified by said second low-noise amplifier into an intermediate frequency signal, a second frequency filter for filtering the intermediate frequency signal converted by said second frequency converter to remove noise components therefrom, and an intermediate frequency amplifier for amplifying the resulting intermediate frequency signal from said second frequency filter and outputting the amplified intermediate frequency signal to said first duplexer.

5. The distributed antenna device as set forth in claim 1 or claim 2, wherein said distributed antenna module is configured in such a manner that radiation and reception directions of each antenna are adjustable three-dimensionally upward, downward, left and right.
